(19) United States
(12) Patent Application Publication
(10) Pub. No.: US 2010/0058404 A1
(43) Pub. Date: Mar. 4, 2010

(54) Fulfilling Extended Video on Demand Customer Content Requests

(75) Inventor: Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television, Inc., Duluth, GA (US)

(21) Appl. No.: 12/204,487

(22) Filed: Sep. 4, 2008

(51) Int. Cl. H04N 7/173

(52) U.S. Cl. 725/93; 725/87; 725/25; 725/131; 725/114

(57) ABSTRACT

Systems and methods are disclosed for a user to initiate a request for program content to a cable services provider wherein the program content is not stored locally at the cable service provider. The cable services provider headend queries a librarian as to a location from which the content may be downloaded. Additionally, the librarian may inform the cable service provider if a license is required in order to download the content. The cable service provider obtains a license, if necessary, and initiates a request for the download from the appropriate content provider. Once obtained, the cable services provider informs the viewer the content is available and streams the content to the viewer.

### FIELD OF THE INVENTION

The present disclosure pertains to fulfilling requests for video on demand (“VOD”) from subscribers on a cable system where the requested content is not immediately available in the cable service provider's system.

### BACKGROUND OF THE INVENTION

Presently, cable service providers offer various services to their cable subscribers, which include the ability for subscribers to request viewing specific programs at the convenience of the viewer. This capability is generically referred to as “video on demand” and allows the user to determine the time and content of what they view. Presently, cable service providers maintain a library of such programs, and present the viewer with a list of titles, and allow the viewer to select the desired program. However, the list of titles is still limited to those made available. The number of such programs available is limited by various factors, including storage and capacity, and logistical factors.

Users, however, expect to have an ever widening selection of choices, ranging from a variety of presently developed programs, to those programs produced decades ago. For example, some viewers may desire to watch a recently produced sports program of their favorite college team, whereas another viewer may desire to watch a classic movie produce fifty years ago. It is not practical for a cable service provider to store the wide range of possible programs that their subscriber base may possibly desire to view. However, cable services providers desire to provide ever increasing service to their subscribers, including providing ready access to any program the view may desire.

Thus, there is a need for improved systems and methods for fulfilling a cable user's request for content while minimizing the storage of such programs by the cable service provider.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 discloses one embodiment of a system according to the principles of the present invention for fulfilling a subscriber's request for content.

FIG. 2 discloses one embodiment of a method according to the principles of the present invention for fulfilling a subscriber's request for content.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Cable subscriber's in a cable system desire to watch programs of their choice at their convenience. Cable service providers have partially met this need by offering video on demand services, which allow the user to select from a list of titles, and request viewing that program at their convenience. However, cable service providers are limited in the set of video programs that can be offered, because such programs have to be stored, and there is not an unlimited storage capability of each cable service provider. Thus, the programs made available are typically those which have a broad appeal, and by definition cannot meet the spectrum of subscriber's desires.

As used herein, “program” refers to a video asset that can be of various formats, e.g., movies, documentaries, television serial programs, sports programs, news programs, etc. Although described in the context of a movie on demand scenario, it is not intended to be limited to only movies.

Further, because a limited amount of programs are locally made available, it is sufficient to present to the user on a video screen a list of program titles, and perhaps with a brief description or characterization (e.g., rating, year produced, etc.) Thus, the user is typically provided with limited searching capabilities. Typically, providing the viewer with a list of titles and perhaps the ability to scroll to another page of titles, is the total scope of the search capabilities provided to the viewer.

With the advent of high speed data communication networks, it is no longer necessary that the set of video-on-demand programs be stored local to the cable service provider. While this provides some benefits for programs that are frequently requested by viewers, it is possible to obtain the content in real time, from a remote source. This allows the cable services provider to expand the library of offerings, into a much larger library. Essentially, any program that can be provided to the cable service provider in real time can be made part of the cable service provider's virtual library of content available to the user. This also provides an additional revenue stream for the cable service provider, as it is possible that obtaining the particular content may be a service which the cable service providers charges for.

This type of arrangement requires that the cable service provider to have existing business arrangements with the sources of the content, and this may require mechanisms for obtaining real time licenses to such programs. One such scheme for obtaining real time licenses for programs is described in U.S. patent application Ser. No. 12/140,591, entitled Digital Rights Management Licensing Over Third Party Networks, filed on Jun. 17, 2008, the contents of which is wholly incorporated in the present disclosure.

The establishment of a business relationship between the cable service provider and the content provider can be initiated and accomplished in various traditional manners. The cable service provider (“CSP”) can initiate a dialogue with the content provider, or a representative, to contract for the downloading of content. Typically, various terms and conditions are negotiated, and a contract is formed. The terms would typically established the terms of use, fees for receiving the content, payment terms, etc. It is foreseen that the content provider will attempt to incite the CSP to advertise or otherwise promote the content from the CSP by offering volume discounts. Thus, if the CSP can guarantee that a certain number of programs will be downloaded from the content provider, the content provider may provide an additional discount to the overall fee, or fees for each program. This discount can be based on an aggregate volume, volume for a particular subject content, or based over time. Those skilled in the art will recognize that various billing algorithms can be used.

The content provider must therefore establish in its server systems the appropriate recognition that requests from the CSP are authorized to be processed. It is expected, but not required, that content providers will require establishment of such a business arrangement in order to establish appropriate verification processes in their billing systems to authenticate requests from the CSP before fulfilling the request. For example, at least the content provider will require programming the CSP identifier into its system so that it can at least recognize the CSP initiating the request for the content. It is expected that a content provider may only accept requests from CSPs which have established a prior business arrangement with the content provider. In addition, various authentication and/or security keys maybe established as part of the business relationship to ensure the security of authenticating the CSP's requests. Thus, before the CSP can offer such programs to its viewers, it must ensure that any requests sent to a content provider are expected to be recognized and processed by the content provider.

Similarly, the CSP must establish billing systems of its own to appropriately bill its subscribers for program content delivered to those viewers. The CSP must also ensure a proper accounting of which subscribers requested what programs, and confirm that the request program was received and downloaded to the set top box, and perhaps, actually viewed by the viewer. The CSP's systems must also account for the programs received from various content providers, to ensure that the bills issued from the content providers actually match up with the programs ordered and received by the CSP.

Having a vast array of programs available for selection to the user requires a more sophisticated method for selecting a program to view. It is not practical to merely list thousands of possible programs for the viewer to select on pages of pages of possible titles. Numerous systems and methods have been identified in the prior art for facilitating program selection or identification of programs to viewers. For example, it is possible to use a viewer's prior selection choices to suggest present choices, or to allow the user to input certain characteristics of programs forming a subset to chose from. For example, a user could indicate a particular category, such as movies or sports, to narrow the selection. Further categories, such as genre, actors/actresses, subject matter, etc. can be solicited and used to provide a more manageable list of choices for the viewer to select from. Any of the prior art methods could be used in conjunction with the principles of the present invention to identify a particular program selected by the viewer.

Once the viewer has selected and identified a particular program to view, this information is communicated to the cable service provider. The CSP may initially screen the request from the viewer to ensure that the viewer is authorized to request and obtain the content. This is accomplished by screening the authorization of the set top box, which is associated with the viewer's account. It is possible that the set top box is determined to be a “blacklisted” set top box (e.g., one that is not recognized or recognized being improper) and to which program content should be not be provided to. In other situations, the set top box is genuine, but the viewer's account is indicated as not allowing certain contents (e.g., no VOD or not VOD of a certain content).

Presuming that there are no restrictions preventing the fulfilling of the request from the set top box, the cable services provider then determines whether the program is locally available, or whether it must be downloaded in real time. In order to accomplish this, the cable services provider must know the source from which to request the program. This presumes that the requested content is not locally stored by the CSP. By locally stored, this means in equipment owned or under the direction and control of the CSP. If the content is locally stored and there is no external DRM license is required, then it is possible that the request can be fulfilled by the CSP using existing VOD procedures. This may entail the CSP providing the decryption keys, which the CSP maintains for fulfilling such request. However, in other embodiments, the CSP may store locally program content which is encrypted and the CSP does not store decryption keys to provide to the viewer. Thus an external DRM license is required. In cases where the CSP does not have a license allowing viewing of the program and the program is locally stored, then the CSP must obtain such a license and this process is described in the aforementioned Digital Rights Management Licensing Over Third Party Networks.

Assuming that the program content is not locally stored, the location where it is stored may be known by the cable services provider, but more than often, the cable services provider will initiate a request to a program librarian, which does not necessarily store the programs, but can inform the cable service provider where it can be located. Then, the cable services provider can then initiate a request to the content source.

In various instances, the content desired may be available, but not without first obtaining a license. This may also be a mechanism by which the content provider is compensated for providing the content. In such cases, the cable services provider may obtain a license in real time from a content licensor, as described in the aforementioned patent application, entitled Digital Rights Management Licensing Over Third Party Networks.

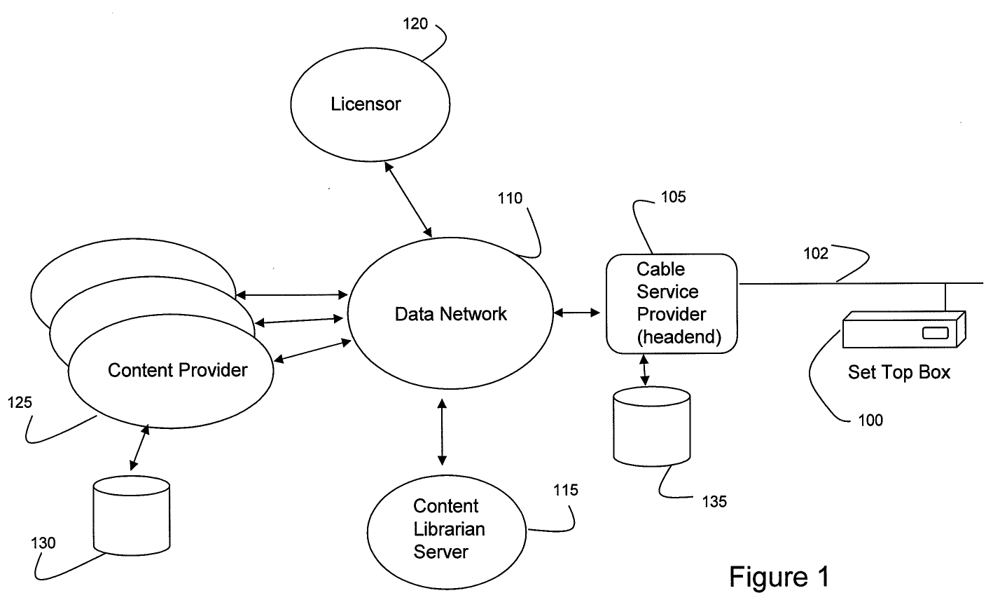

Turning to FIG. 1, one embodiment for a system developed according to the principles of the present invention is shown. In FIG. 1, a set top box (“STB”) 100 is shown as being located in the viewer's premises. Although the present specification discloses the invention in terms of using a STB, other embodiments are possible. These would include using a personal computer, video disk player, or television that incorporates the same functionality. The STB additionally may be used to provide a menu-driven mechanism in conjunction with the television (not shown) for facilitating the user's selection and identification of a particular program. This typically relies on the user interacting with the remote control (not shown) to identify the categories or other information regarding a desired program.

The STB is shown as connected to a cable network 102, but other methods are possible, including wireless media (e.g., fixed location wireless data transmission). Fiber optic and hybrid fiber coax network infrastructure may be used. The cable network 102 is connected to a cable service provider (“CSP”) which services the viewer. Specifically, the equipment in the CSP is referred to as the ‘head-end’, and as used herein, this refers to the equipment used by the CSP to accomplish the communication necessary with the other entities described below. The CSP receives the request for the content, and typically, the information includes some unique identifier associated with the program. For example, if the user selects a particular program as presented by the STB, the STB may return a numerical value associated with the desired program. This requires each program to have a unique identifier.

The CSP may have a local store comprising a database 135 of programs, which would likely correspond to those popular programs most likely to be requested by the CSP's viewers. In such cases, there is no need for the CSP to request a source of the content from the Librarian.

Assuming that the CSP does not have local access to the requested content, the CSP can initiate a request to a Librarian 115 as to where the program content may be obtained. This is typically done by initiating a request over a data network 110, such as the Internet, to a predetermined location. The Librarian would maintain a list of content providers and which is able to provide the requested content. If two or more content providers can provide the program, the Librarian may have knowledge as to the terms on which each provider offers the content. For example, some programs may not be exclusive controlled by a single content provider, and they may offer their content at different rates. In this case, the Librarian may select the one having the less expensive rate, or inform the CSP (which in turn may inform the user) of the cost of downloading each program.

It is possible that the Librarian 115 will communicate in real time with the appropriate content providers 125 to inquire or verify the availability of the particular program selected. This may require translating the program identifier value indicated by the CSP into a value recognized by each content provider. If, however, such identifiers are standardized, then this is not required. Once the Librarian has the necessary information, it will inform the CSP, which may then inform the STB to confirm availability and/or other information from the viewer.

Once confirmed, and the CSP now knows the appropriate content provider, the CSP will initiate a request of the program to the appropriate content provider 125. Typically, the content provider will maintain a library of programs in a database 130, which are downloaded over the data network to the CSP. Typically, there are a multiple of content providers available, which largely maintain separate databases of distinct programs.

In some instances, the content provider may license the content, which again provides a revenue stream to the content provider, and also to the CSP. Additional details may be found in the aforementioned patent application, Digital Rights Management Licensing Over Third Party Networks. In such instances, the Content Provider 125 or the Librarian may inform the CSP that a license is required, and the CSP may request the license from the licensor. The Librarian can also perform the function of informing the CSP which of several licensors is authorized to grant licenses for the selected program, if one is required.

After the appropriate authorizations are obtained, and evidence of such is provided to the Content Provider, the Content Provider will download the content to the CSP, where is it stored locally in database 135 as the program is played out to the viewer. In some cases, the program may have a implied or express longevity for which it can be stored in the local database 135. It is possible that a viewer can request content for later viewing as well, and hence the program must be stored for a limited duration.

The individual components of the Librarian 115, content provider 125, and licensor 120 and CSP involve standard computing devices, such as readily commercially available, and include processors, memory, disk storage, interfaces, etc.

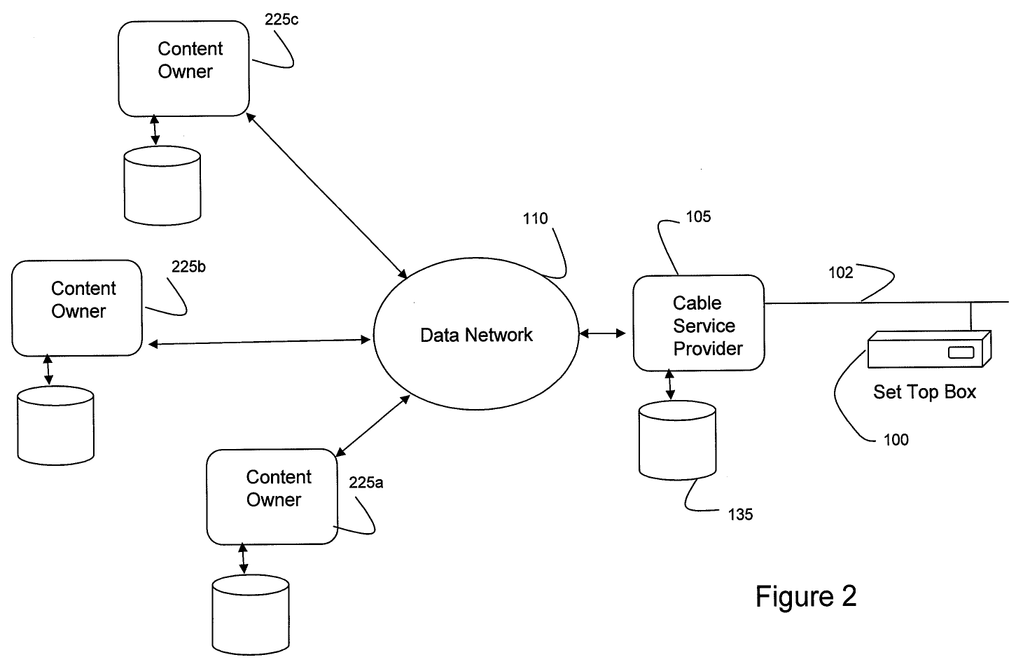

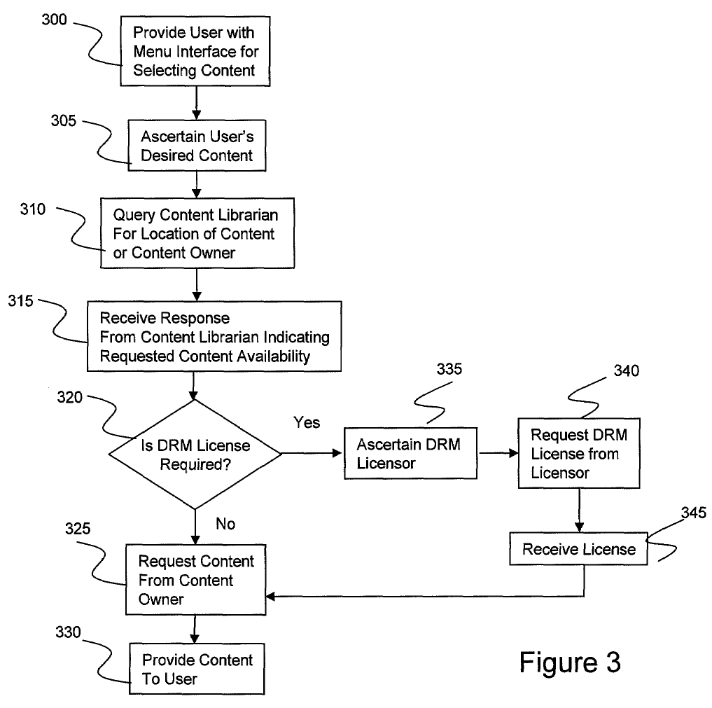

FIG. 2 illustrates another embodiment, where the function of librarian is replaced in a manner. In this embodiment, the CSP 105 upon determining a particular program requested by the user, initiates a request to several content owners 225a, b, c. Essentially, the request for the program is broadcast to a known set of content providers, and each will response indicating whether they have the asset or not. In this way, the CSP can readily ascertain which of several content providers the download will originate from. It is likely that in this scenario, the CSP may have an established business relationship with the three content providers for obtaining such programs. While this scheme does is likely to result in a more limited universe of programs available to the CSP, it can still significantly expand the library of programs that the CSP can offer to the viewer.

Turning to FIG. 3, a flowchart is shown of one embodiment of the processing involved at the CSP for servicing requests for program content, wherein the program content is not locally stored by the CSP.

The first step 300 provides the user with a graphical user interface for facilitating the selection of programs. The interface is can be provided by the STB providing an interactive interface for selecting attributes of the program that the viewer desires. This can be accomplished by an application program downloaded to the STB, and in other embodiments, a subset or the entire list of program titles (or other information) can be downloaded to the STB. The information can be periodically obtained by the CSP from the Librarian (e.g., nightly) and downloaded to the STB. Alternatively, the STB may determine a category and then query the Librarian for a list of programs in this category. Various techniques and methods can be used for interacting with the viewer to obtain the selection and identification of a particular program. This information, e.g., the selected program is then communicated to the CSP so that at step 305, the user's desired program has been determined.

Next, at step 310, the CSP initiates a query to the Librarian, indicating the desired program content requested by the viewer. The Librarian may retrain various attributes associated with the program, such as time, rating, the programs actors, subject matter, year produced, etc. These can be provided to the CSP, which in turn provides the information to the viewer. The Librarian also maintains information about how and/or where the CSP can obtain the program content. For example, a URL address or other identifier associated with the content owner or content provider can stored by the Librarian. Additionally, the Librarian may store other information regarding the program, such as business terms associated with the downloading of the program. This information may be provided to the CSP, which in turn provides it the viewer as supplemental information involved in the confirmation that the viewer is selecting the program. Although these steps are not explicitly shown, one skilled in the art can recognize the such interaction may occur an be part of the selection process.

In step 315, the CSP is informed of information regarding the program, including where the content can be obtained from and whether a license is requested. If a digital rights management (“DRM”) license is required as shown in step 320, the CSP may be required to obtain a license from a third party licensor. If so, then the CSP will have to ascertain in steps 335 where to request the license from, and initiate the request at step 340. Further details may be found in Digital Rights Management Licensing Over Third Party Networks, the contents of which are incorporated by reference. Once the license is received in step 345, the CSP can then initiate the request for the content from the content owner.

In step 325, the CSP initiates a request for the content from the content owner. In some cases, the owner of the content may not be the provider of the content, as the content owner may deposit a copy of the program with a provider that stores the content, and provides it upon request. However, for practical purposes, it can be assumed that the content owner is the same entity providing the content. There may be further interaction between steps 325 and 330 where the content provider verifies the requester, or otherwise performs a transaction with the CSP for performing any preliminary steps required to download the content. For example, the CSP may be a recognized customer of the content provider, and authentication is required from the CSP before the content is downloaded. Alternatively, if a license is required, the CSP may have to provide evidence of having obtained a license, or alternatively, request a license from the content provider first. Once any pre-requisite steps are completed, then the content is downloaded to the user in step 330.

The CSP may inform the user that the program is ready for viewing, and wait for a confirmation from the user. This may include providing the viewer with information about any costs or other charges associated with the viewing of the content. The program content maybe stored in a local database for a limited duration of time, so that it can be viewed at a time more convenient to the viewer. Alternatively, the CSP could immediately begin to stream to the program to the user. It is expected that the above steps would occur fairly quickly so that any delay from the user initiating the request and the streaming of content would be minimal. However, if there is a delay, the CSP could send a message to the STB, which would result in information the viewer that their requested download is available for viewing, and interact with the user as to when they would like to view the program.

The CSP may also update billing systems upon either the downloading of the program to the viewer, or after completion of, or upon initiating viewing of the program by the viewer. The CSP may also provide a confirmation of the same to the content provider, if the content provider requires such for accounting purposes.

In other embodiments, the viewer maybe able to view the program once, a limited number of times, or as many times as possible during a limited time period.

That which is claimed:

1. A method for a cable service provider to fulfill a request for program content from a user, comprising the steps of:
establishing a business relationship with a content provider resulting in authorization by the content provider to process a program content request from the cable service provider;
receiving a first request for program content at the cable service provider from a set top box associated with said user on a cable service provider's network wherein the first request includes a program content identifier identifying the program content;
verifying at the cable service provider that the first request from the set top box is authorized to be processed by the cable service provider;
determining in the cable service provider that the program content is not locally stored in a database available to the cable service provider;
determining a content librarian server to initiate a second request from the cable service provider for requesting identification of the content provider capable of providing the program content;
transmitting the second request from the cable service provider to the content librarian server requesting identification of the content provider;
receiving a response at the cable service provider from the content librarian server identifying the content provider;
generating the program content request to the content provider requesting the program content;
receiving the program content at the cable service provider from the program content provider;
transmitting the program content over the cable service provider's network to the set top box; and
updating a billing record at the cable service provider of the user account associated with the set top box to reflect fulfilling said first request for program content.

2. The method of claim 1 further comprising the steps of:
determining in the cable service provider that the program content requires a digital rights management license for viewing;
initiating a third request from the cable service provider to a licensor for the digital rights management license wherein the third request includes the program content identifier; and
transmitting the digital rights management license to the set top box.

3. The method of claim 2 wherein the content librarian server provides an indication to the cable service provider that the digital rights management license is required for viewing.

4. The method of claim 3 wherein the content librarian server provides an address of the licensor to the cable service provider.

5. The method of claim 1 wherein the cable service provider transmits a list of program content identifiers to the set top box, said list of program content identifiers including said program content identifier and wherein at least portion of said program content identifiers correspond to program content that is not stored in the cable service provider's network.

6. The method of claim 5 wherein the cable service provider receives said list of program content identifiers from said content librarian server and downloads at least a subset thereof to the set top box prior to receiving the first request for program content from the set top box.

7. The method of step 1 wherein the step of
receiving a response at the cable service provider from the content librarian server identifying the content provider comprises:
receiving a response at the cable service provider from the content librarian server identifying the content provider along with a plurality of content providers; and
selecting the content provider at the cable service provider from among the plurality of content providers.

8. The method of claim 1 further comprising the step of:
providing from the cable service provider to the set top box an indication that said program content has been received from the content provider and ready for viewing.

9. The method of claim 1 further comprising the step of:
downloading an application software module from the cable services provider to the set top box for interacting with the user to facilitate identification of the program content identifier wherein the program content is not stored locally at the cable service provider's network.

10. The method of claim 5 further comprising:
receiving a program attribute from the set top box which is used to query the content librarian server to obtain the list of program content identifiers to transmit to the set top box.

11. A system for fulfilling requests for program content from a user comprising:
a set top box configured to interactively determine the user's request for viewing said program content;
a cable network connected to the set top box for conveying a request from the set top box indicating the request for viewing the program content; and
a cable headend connected to the cable network receiving said request for viewing the program content,
said cable headend configured to determine in a local database that said program content is not stored in said local database,
said cable headend configured to initiate a query to a content librarian server requesting an identifier of a content provider capable of providing said program content,
said cable headend further configured to receive a response from said content librarian server identifying said content provider and generating in response a second query to said content provider requesting download of said program content,
said cable headend further configured to receive said program content from said content provider and store said program content in said local database, and
said cable headend further configured to stream said program content to said set top box.

12. The system of claim 11 wherein said response from said content librarian server further comprises an indication that a digital rights management license is required for viewing the program content.

13. The system of claim 12 wherein said response further includes an identification of a licensor from which a request for said digital rights management license can be requested from.

14. The system of claim 12 wherein the cable headend is further configured to generate a request for said digital rights management license, and
wherein the cable headend is further configured to transmit said digital rights management license to said set top box.

15. The system of claim 11 wherein the set top box is further configured to receive a list program content identifiers which includes said program content identifier wherein some of the program content identifiers identify program content not locally stored at the cable headend.

16. The system of claim 15 wherein the cable headend is further configured to download an application program to the set top box to facilitate the user selecting said program content identifier.

17. The system of claim 11 wherein the said cable headend is further configured to initiate a query to a content librarian server requesting a list of program content identifiers which includes said program content identifier.

18. The system of claim 11 wherein the cable headend is configured to provide an indication to the set top box that the program content is received from said content provider and available for viewing.

19. The system of claim 14 wherein the cable headend is configured to ascertain that the set top box is authorized to receive said digital rights management license.

20. The system of claim 14 wherein the cable headened is configured to update a billing record associated with set top box after streaming said program content to the set top box.
